(19) United States
(12) Patent Application Publication
(10) Pub. No.: US 2026/0233753 A1
(43) Pub. Date: Aug. 13, 2026

(54) SMART TRAVEL COMPANION

(71) Applicant: GM Global Technology Operations LLC, Detroit, MI (US)

(72) Inventors: Prakash M. Peranandam, Rochester Hills, MI (US); Armando Antonio Beltran Pacheco, Rochester Hills, MI (US); Azeem Sarwar, Rochester Hills, MI (US); Arun Adiththan, Sterling Heights, MI (US); Paolo Giusto, Brentwood, CA (US); Ramesh Sethu, Troy, MI (US); Rami Ismail Debouk, Dearborn, MI (US); Md Mhafuzul Islam, Warren, MI (US)

(21) Appl. No.: 19/050,678

(22) Filed: Feb. 11, 2025

(51) Int. Cl. B60W 60/00; B60W 40/08; B60W 50/00; B60W 50/10; B60W 50/14; G06F 40/20

(52) U.S. Cl. CPC B60W 60/001; B60W 40/08; B60W 50/0097; B60W 50/10; B60W 50/14; G06F 40/20; B60W 2040/089; B60W 2050/143; B60W 2050/146; B60W 2540/21; B60W 2540/225; B60W 2556/10; B60W 2556/45

(57) ABSTRACT

A system for providing intention-based infotainment within a vehicle includes system controller adapted to collect data related to intentions of an occupant within the vehicle, develop a request based on the data related to the intentions of the occupant within the vehicle, collect data from the plurality of onboard sensors related to the request, receive, via a wireless communication module, data from remote sources related to the request, formulate, with a large language model (LLM) in communication with the system controller, via the wireless communication module, a response, and actuate systems within the vehicle to automatically, at least one of, provide, via a human machine interface (HMI), infotainment content for the occupant within the vehicle, and control, via an automated driving assistance system (ADAS), operation of the vehicle.

### INTRODUCTION

The present disclosure relates to a system and method for providing intention-based infotainment within a vehicle.

Current infotainment systems within vehicle are adapted to provide various communication, notification and entertainment aspects for occupants within the vehicle. However, current systems are limited to providing static infotainment content that is specifically requested.

Thus, while current systems and methods achieve their intended purpose, there is a need for a new and improved system and method for providing infotainment content based on an occupant's intentions derived from analysis of data with a large language model and machine learning algorithms to automatically provide dynamic and interactive infotainment content.

### SUMMARY

According to several aspects of the present disclosure, a method of providing intention-based infotainment within a vehicle, comprising, with a system controller in communication with a plurality of onboard sensors within the vehicle, collecting data related to intentions of an occupant within the vehicle, developing a request based on the data related to the intentions of the occupant within the vehicle, collecting data from the plurality of onboard sensors related to the request, receiving, via a wireless communication module, data from remote sources related to the request, formulating, with a large language model (LLM) in communication with the system controller via the wireless communication module, a response, and actuating systems within the vehicle to automatically, at least one of provide, via a human machine interface (HMI), infotainment content for the occupant within the vehicle, and control, via an automated driving assistance system (ADAS), operation of the vehicle.

According to another aspect, the collecting data related to intentions of an occupant within the vehicle further includes at least one of collecting, with an occupant monitoring system data related to what the occupant is looking at, gestures made by the occupant, and facial expressions of the occupant, and collecting, with the HMI, verbal expressions made by the occupant and manual data input from the occupant.

According to another aspect, the collecting data related to intentions of an occupant within the vehicle further includes accessing, with a machine learning model, stored data within a database related to past occurrences of the occupant using the vehicle.

According to another aspect, the developing a request based on the data related to the intentions of the occupant within the vehicle further includes detecting, with the system controller, one of triggering language from the occupant, via the HMI, or a triggering event, via the plurality of onboard sensors.

According to another aspect, the developing a request based on the data related to the intentions of the occupant within the vehicle further includes predicting, with the machine learning model, intentions of the occupant based on the data stored within the database, analyzing, with the LLM, the data related to the intentions of the occupant within the vehicle, identifying, with the machine learning model and the LLM, key terms and qualifier terms, and quantifying, with the system controller, using the LLM, the machine learning model, real time data collected by the plurality of onboard sensors and data received from remote sources, the key terms and qualifier terms.

According to another aspect, the collecting data from the plurality of onboard sensors related to the request and the receiving, via the wireless communication module, data from remote sources related to the request further includes identifying, with the system controller, a geographic area within which relevant data related to the request will be collected, collecting relevant data related to the request within the geographic area, and filtering the collected data based on the key terms and qualifier terms.

According to another aspect, the collecting data from the plurality of onboard sensors related to the request and the receiving, via the wireless communication module, data from remote sources related to the request further includes identifying, with the system controller, using the machine learning model, unspecified key terms and unspecified qualifier terms, related to the request and not included within the request.

According to another aspect, the collecting data from the plurality of onboard sensors related to the request and the receiving, via the wireless communication module, data from remote sources related to the request further includes identifying, with the system controller, an extended geographic area within which relevant data related to the request, including unspecified key terms and unspecified qualifier terms, will be collected, collecting relevant data related to the request within the extended geographic area, and filtering the collected data based on the key terms, qualifier terms, unspecified key terms and unspecified qualifier terms.

According to another aspect, the formulating, with a large language model (LLM) in communication with the system controller via the wireless communication module, a response, and actuating systems within the vehicle to automatically provide, via the HMI, infotainment content for the occupant within the vehicle further includes formulating, with the LLM, a natural language response for the occupant; and at least one of displaying a textual language response on a touch screen display of the HMI, and broadcasting, via a speaker associated with the HMI, a verbal response for the occupant.

According to another aspect, the formulating, with a large language model (LLM) in communication with the system controller via the wireless communication module, a response, and actuating systems within the vehicle to automatically control, via an automated driving assistance system (ADAS), operation of the vehicle further includes identifying, with the LLM and the machine learning model, a desired vehicle operation based on the request, and automatically, via the ADAS, performing the desired vehicle operation.

According to several aspects of the present disclosure, a system for providing intention-based infotainment within a vehicle includes a system controller in communication with a plurality of onboard sensors within the vehicle and adapted to collect data related to intentions of an occupant within the vehicle, develop a request based on the data related to the intentions of the occupant within the vehicle, collect data from the plurality of onboard sensors related to the request, receive, via a wireless communication module, data from remote sources related to the request, formulate, with a large language model (LLM) in communication with the system controller, via the wireless communication module, a response, and actuate systems within the vehicle to automatically, at least one of provide, via a human machine interface (HMI), infotainment content for the occupant within the vehicle, and control, via an automated driving assistance system (ADAS), operation of the vehicle.

According to another aspect, when collecting data related to intentions of an occupant within the vehicle, the system controller is further adapted to at least one of collect, with an occupant monitoring system data related to what the occupant is looking at, gestures made by the occupant, and facial expressions of the occupant, and collect, with the HMI, verbal expressions made by the occupant and manual data input from the occupant.

According to another aspect, when collecting data related to intentions of an occupant within the vehicle, the system controller is further adapted to access, with a machine learning model, stored data within a database related to past occurrences of the occupant using the vehicle.

According to another aspect, when developing a request based on the data related to the intentions of the occupant within the vehicle, the system controller is further adapted to detect one of triggering language from the occupant, via the HMI, or a triggering event, via the plurality of onboard sensors.

According to another aspect, when developing a request based on the data related to the intentions of the occupant within the vehicle, the system controller is further adapted to predict, with the machine learning model, intentions of the occupant based on the data stored within the database, analyze, with the LLM, the data related to the intentions of the occupant within the vehicle, identify, with the machine learning model and the LLM, key terms and qualifier terms, and quantify, using the LLM, the machine learning model, real time data collected by the plurality of onboard sensors and data received from remote sources, the key terms and qualifier terms.

According to another aspect, when collecting data from the plurality of onboard sensors related to the request and receiving, via the wireless communication module, data from remote sources related to the request, the system controller is further adapted to identify a geographic area within which relevant data related to the request will be collected, collect relevant data related to the request within the geographic area, and filter the collected data based on the key terms and qualifier terms.

According to another aspect, when collecting data from the plurality of onboard sensors related to the request and receiving, via the wireless communication module, data from remote sources related to the request, the system controller is further adapted to identify, using the machine learning model, unspecified key terms and unspecified qualifier terms, related to the request and not included within the request.

According to another aspect, when collecting data from the plurality of onboard sensors related to the request and receiving, via the wireless communication module, data from remote sources related to the request, the system controller is further adapted to identify an extended geographic area within which relevant data related to the request, including unspecified key terms and unspecified qualifier terms, will be collected, collect relevant data related to the request within the extended geographic area, and filter the collected data based on the key terms, qualifier terms, unspecified key terms and unspecified qualifier terms.

According to another aspect, when formulating, with a large language model (LLM) in communication with the system controller via the wireless communication module, a response, and actuating systems within the vehicle to automatically provide, via the HMI, infotainment content for the occupant within the vehicle, the system controller is further adapted to formulate, with the LLM, a natural language response for the occupant, and at least one of display a textual language response on a touch screen display of the HMI, and broadcast, via a speaker associated with the HMI, a verbal response for the occupant, and when formulating, with a large language model (LLM) in communication with the system controller via the wireless communication module, a response, and actuating systems within the vehicle to automatically control, via an automated driving assistance system (ADAS), operation of the vehicle, the system controller is further adapted to identify, with the LLM and the machine learning model, a desired vehicle operation based on the request, and automatically, via the ADAS, perform the desired vehicle operation.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic diagram of a vehicle having a system for providing intention-based infotainment content according to an exemplary embodiment;

FIG. 2 is a schematic diagram of the system according to an exemplary embodiment;

FIG. 3 is a schematic diagram illustrating a subject vehicle with an occupant seated therein traveling on a roadway;

FIG. 4 is a schematic diagram illustrating a geographical area and an extended geographical area within which the system will search for data related to a request; and

FIG. 5 is a flow chart illustrating a method according to an exemplary embodiment.

The figures are not necessarily to scale and some features may be exaggerated or minimized, such as to show details of particular components. In some instances, well-known components, systems, materials or methods have not been described in detail in order to avoid obscuring the present disclosure. Therefore, specific structural and functional details disclosed herein are not to be interpreted as limiting, but merely as a basis for the claims and as a representative basis for teaching one skilled in the art to variously employ the present disclosure.

### DETAILED DESCRIPTION

The following description is merely exemplary in nature and is not intended to limit the present disclosure, application, or uses. Furthermore, there is no intention to be bound by any expressed or implied theory presented in the preceding technical field, background, brief summary or the following detailed description. It should be understood that throughout the drawings, corresponding reference numerals indicate like or corresponding parts and features. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality. Although the figures shown herein depict an example with certain arrangements of elements, additional intervening elements, devices, features, or components may be present in actual embodiments. It should also be understood that the figures are merely illustrative and may not be drawn to scale.

As used herein, the term “vehicle” is not limited to automobiles. While the present technology is described primarily herein in connection with automobiles, the technology is not limited to automobiles. The concepts can be used in a wide variety of applications, such as in connection with aircraft, marine craft, other vehicles, and consumer electronic components.

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about”, with reference to percentages, comprises a variation of plus/minus 5%, “about”, with reference to temperatures, comprises a variation of plus/minus five degrees, and “about”, with reference to distances (widths, heights, lengths), comprises plus/minus 10%. In addition, disclosure of ranges includes disclosure of all values and further divided ranges within the entire range, including endpoints and sub-ranges given for the ranges. In addition, disclosure of ranges includes disclosure of all values and further divided ranges within the entire range, including endpoints and sub-ranges given for the ranges.

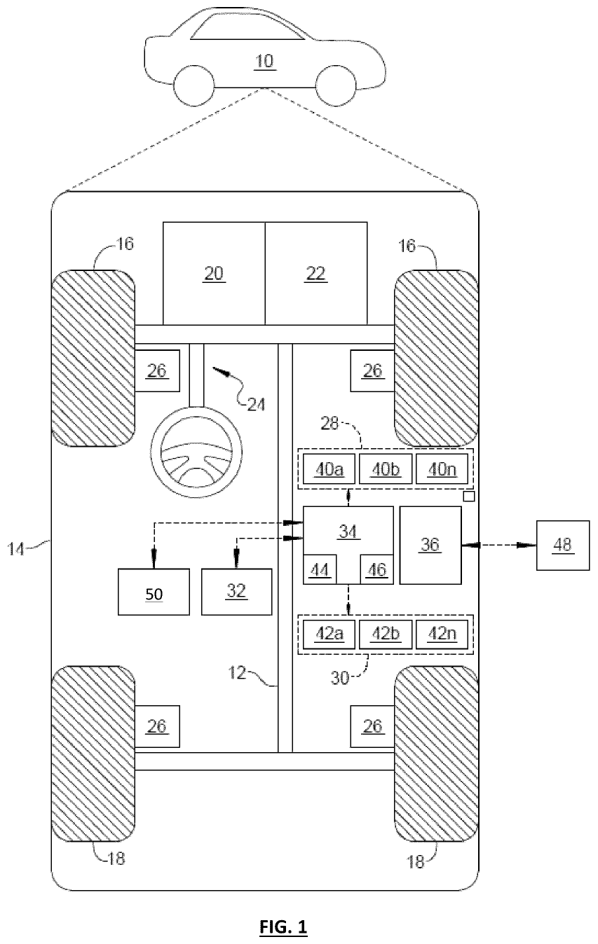

In accordance with an exemplary embodiment, FIG. 1 shows a subject vehicle 10 with an associated system 50 for providing intention-based infotainment within the vehicle 10. In general, the system 50 works in conjunction with other systems within the vehicle 10 to display various information and provide infotainment content for an occupant within vehicle 10. The subject vehicle 10 generally includes a chassis 12, a body 14, front wheels 16, and rear wheels 18. The body 14 is arranged on the chassis 12 and substantially encloses components of the subject vehicle 10. The body 14 and the chassis 12 may jointly form a frame. The front wheels 16 and rear wheels 18 are each rotationally coupled to the chassis 12 near a respective corner of the body 14.

In various embodiments, the vehicle 10 is an autonomous vehicle and the system 50 is incorporated into the autonomous vehicle 10 and communicates with an automated driver assistance system (ADAS) 52. An autonomous vehicle 10 is, for example, a vehicle 10 that is automatically controlled to carry passengers from one location to another. The vehicle 10 is depicted in the illustrated embodiment as a passenger car, but it should be appreciated that any other vehicle including level 2 automobile, motorcycles, trucks, sport utility vehicles (SUVs), recreational vehicles (RVs), airplanes, boats, etc., can also be used. In an exemplary embodiment, the vehicle 10 is equipped with a so-called Level Four or Level Five automation system. A Level Four system indicates “high automation”, referring to the driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver. The novel aspects of the present disclosure are also applicable to non-autonomous vehicles.

As shown, the vehicle 10 generally includes a propulsion system 20, a transmission system 22, a steering system 24, a brake system 26, a sensor system 28, an actuator system 30, at least one data storage device 32, a vehicle controller 34, and a wireless communication module 36. In an embodiment in which the vehicle 10 is an electric vehicle, there may be no transmission system 22. The propulsion system 20 may, in various embodiments, include an internal combustion engine, an electric machine such as a traction motor, and/or a fuel cell propulsion system. The transmission system 22 is configured to transmit power from the propulsion system 20 to the vehicle's front wheels 16 and rear wheels 18 according to selectable speed ratios. According to various embodiments, the transmission system 22 may include a step-ratio automatic transmission, a continuously-variable transmission, or other appropriate transmission. The brake system 26 is configured to provide braking torque to the vehicle's front wheels 16 and rear wheels 18. The brake system 26 may, in various embodiments, include friction brakes, brake by wire, a regenerative braking system such as an electric machine, and/or other appropriate braking systems. The steering system 24 influences a position of the front wheels 16 and rear wheels 18. While depicted as including a steering wheel for illustrative purposes, in some embodiments contemplated within the scope of the present disclosure, the steering system 24 may not include a steering wheel.

The sensor system 28 includes one or more onboard sensors 40a-40n that sense observable conditions of the exterior environment and/or the interior environment of the vehicle 10. The onboard sensors 40a-40n can include, but are not limited to, radars, lidars, global positioning systems, optical cameras, thermal cameras, ultrasonic sensors, and/or other sensors. The cameras can include two or more digital cameras spaced at a selected distance from each other, in which the two or more digital cameras are used to obtain stereoscopic images of the surrounding environment in order to obtain a three-dimensional image or map. The plurality of onboard sensors 40a-40n is used to determine information about an environment surrounding the vehicle 10. In an exemplary embodiment, the plurality of onboard sensors 40a-40n includes at least one of a motor speed sensor, a motor torque sensor, an electric drive motor voltage and/or current sensor, an accelerator pedal position sensor, a coolant temperature sensor, a cooling fan speed sensor, and a transmission oil temperature sensor. In another exemplary embodiment, the plurality of onboard sensors 40a-40n further includes sensors to determine information about the environment surrounding the vehicle 10, for example, an ambient air temperature sensor, a barometric pressure sensor, and/or a photo and/or video camera which is positioned to view the environment in front of the vehicle 10. In another exemplary embodiment, at least one of the plurality of onboard sensors 40a-40n is capable of measuring distances in the environment surrounding the vehicle 10.

In a non-limiting example wherein the plurality of onboard sensors 40a-40n includes a camera, the plurality of onboard sensors 40a-40n measures distances using an image processing algorithm configured to process images from the camera and determine distances between objects. In another non-limiting example, the plurality of onboard sensors 40a-40n includes a stereoscopic camera having distance measurement capabilities. In one example, at least one of the plurality of onboard sensors 40a-40n is affixed inside of the vehicle 10, for example, in a headliner of the vehicle 10, having a view through the windshield of the vehicle 10. In another example, at least one of the plurality of onboard sensors 40a-40n is affixed outside of the vehicle 10, for example, on a roof of the vehicle 10, having a view of the environment surrounding the vehicle 10. It should be understood that various additional types of sensing devices, such as, for example, LiDAR sensors, ultrasonic ranging sensors, radar sensors, cameras and/or time-of-flight sensors are within the scope of the present disclosure. The actuator system 30 includes one or more actuator devices 42a-42n that control one or more vehicle 10 features such as, but not limited to, the propulsion system 20, the transmission system 22, the steering system 24, and the brake system 26.

The system 50 includes an occupant monitoring system 54 that receives data from at least one camera includes within the plurality of onboard sensors 40a-40n. The occupant monitoring system 54 is adapted to detect movements of the head and eyes of occupants within the vehicle 10 to determine a direction which the occupant is looking and to what the occupant is looking at. The occupant monitoring system 54 is further adapted to monitor gestures made by an occupant using either head movements, such as nodding, or hand gestures.

The vehicle controller 34 includes at least one processor 44 and a computer readable storage device or media 46. The at least one data processor 44 can be any custom made or commercially available processor, a central processing unit (CPU), a graphics processing unit (GPU), an auxiliary processor among several processors associated with the vehicle controller 34, a semi-conductor based microprocessor (in the form of a microchip or chip set), a macro-processor, any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the at least one data processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the vehicle controller 34 in controlling the vehicle 10 and the system 50.

The instructions may include one or more separate programs, each of which includes an ordered listing of executable instructions for implementing logical functions. The instructions, when executed by the at least one processor 44, receive and process signals from the sensor system 28, perform logic, calculations, methods and/or algorithms for automatically controlling the components of the vehicle 10, and generate control signals to the actuator system 30 to automatically control the components of the vehicle 10 based on the logic, calculations, methods, and/or algorithms. Although only one vehicle controller 34 is shown in FIG. 1, embodiments of the vehicle 10 can include any number of controllers 34 that communicate over any suitable communication medium or a combination of communication mediums and that cooperate to process the sensor signals, perform logic, calculations, methods, and/or algorithms, and generate control signals to automatically control features of the autonomous vehicle 10.

In various embodiments, one or more instructions of the vehicle controller 34 are embodied in a trajectory planning system and, when executed by the at least one data processor 44, generates a trajectory output that addresses kinematic and dynamic constraints of the environment. For example, the instructions receive as input process sensor and map data. The instructions perform a graph-based approach with a customized cost function to handle different road scenarios in both urban and highway roads.

The wireless communication module 36 is configured to wirelessly communicate information to and from other remote entities 48, such as but not limited to, other vehicles (“V2V” communication,) infrastructure (“V2I” communication), remote systems, remote servers, cloud computers, and/or personal devices. In an exemplary embodiment, the wireless communication module 36 is a wireless communication system configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

The vehicle controller 34 is a non-generalized, electronic control device having a preprogrammed digital computer or processor, memory or non-transitory computer readable medium used to store data such as control logic, software applications, instructions, computer code, data, lookup tables, etc., and a transceiver [or input/output ports]. Computer readable medium includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device. Computer code includes any type of program code, including source code, object code, and executable code.

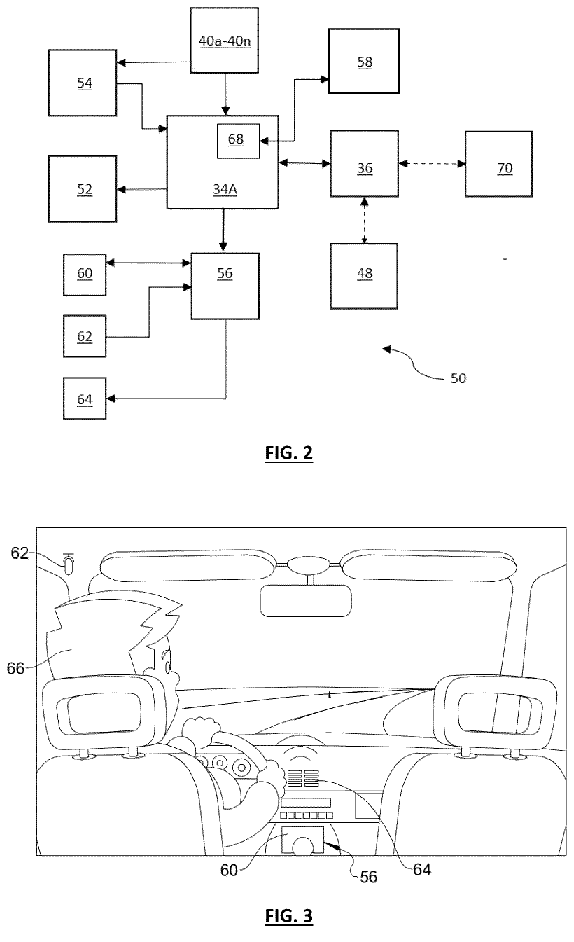

Referring to FIG. 2 a schematic diagram of the system 50 is shown. The system 50 includes a system controller 34A in communication with the plurality of onboard sensors 40a-40n, the ADAS 52, the occupant monitoring system 54, a human machine interface (HMI) 56, a database 58 and the wireless communication module 36. The system controller 34A may be the vehicle controller 34, or the system controller 34A may be a separate controller in communication with the vehicle controller 34.

Referring to FIG. 3, the HMI 56 may include a touch screen display screen 60 on which infotainment content may be displayed by the system controller 34A, wherein an occupant 66 is capable of interacting with the system 50 via interaction with the touch screen display 60 and/or through verbal inputs picked up by a microphone 62 associated with the HMI 56. In an exemplary embodiment, a speaker 64 associated with the HMI 56 is adapted to allow the system to broadcast verbal infotainment content for occupants 66 within the vehicle 10. In another exemplary embodiment, the HMI 56 is associated with a head-up-display within the vehicle 10 and in communication with the system controller 34A, wherein the system controller 34A can utilize the head-up-display to display infotainment content onto an inner surface of the windshield of the vehicle 10 in addition to displaying the infotainment content on the touch screen display 60 of the HMI 56.

In an exemplary embodiment, the system controller 34A is adapted to collect data related to intentions of an occupant 66 within the vehicle 10. When collecting such data, the system controller 34A communicates with multiple ones of the plurality of onboard sensors 40a-40n and the occupant monitoring system 54 to gather data related to intentions of the occupant 66 within the vehicle 10. The system controller 34A collects, with the occupant monitoring system 54 data related to what the occupant 66 is looking at, gestures made by the occupant 66, and facial expressions of the occupant 66, and collects, with the HMI 54, verbal expressions made by the occupant 66 and manual data input from the occupant 66. The system controller 34A also collects basic data related to credentials and subscriptions that the occupant 66 may have to determine what third-party service providers the occupant 66 may have access to, and vehicle operating parameters collected via the plurality of onboard sensors 40a-40n.

For example, the system controller 34A, via the microphone 62 associated with the HMI 54, picks up verbal data from the occupant 66, wherein the occupant 66 says “Hey Vehicle. Find a good hotel with optional breakfast and a gym within about thirty to forty-five minutes and not too far from the highway.”

In an exemplary embodiment, the system controller 34A is adapted to actuate the system 50 upon detection of either triggering language from the occupant 66, via the HMI, or a triggering event, via the plurality of onboard sensors. In the example, above, the system controller 34A detects the triggering language “Hey Vehicle”, which triggers the system controller 34A. Alternatively, the system controller 34A may be triggered by an event, wherein the system controller 34A actuates the system to provide infotainment content based on detection of an upcoming vehicular event, such as a left turn, or approaching an intersection, etc. The triggering event may be any occurring or upcoming circumstance that the system controller 34A recognizes that the occupant 66 may desire specific infotainment content. The system controller 34A may utilize a machine learning model and machine learning algorithms, discussed in detail below, to analyze and quantify potential triggering events.

Once triggered, the system controller 34A recognizes the verbal input from the occupant 66, “Find a good hotel with optional breakfast and a gym within about thirty to forty-five minutes and not too far from the highway”, recognizes the occupant 66 intentions to find a good hotel, and builds a request based on the verbal input. In this example, the occupant has provided an explicit verbal command which defines the request. The system controller 34A may also identify intentions of the occupant 66 by accessing, with a machine learning model 68, stored data within the database 58 related to past occurrences of the occupant 66 using the vehicle 10. Using the machine learning model 68 and machine learning algorithms, the system controller 34A probabilistically predicts the intentions of the occupant 66 based on past behavior.

Various techniques are employed to extract meaningful features from sensor readings and data, including time-series analysis, frequency-domain analysis, and spatial-temporal patterns. The machine learning model 68 may be one of, but not limited to, Long Short-Term Memory (LSTM), Gated Recurrent Unit (GRU), Decision Trees, Random Forests, Support Vector Machines (SVM), Neural Networks (NN), K-Nearest Neighbors (KNN), Gradient Boosting and Recurrent Neural Networks (RNN).

Thus, the system controller 34A uses the machine learning model 68 and machine learning techniques to predict current intentions of the occupant 66 based on analyzing real-time data of the location of the vehicle 10, the operating conditions (date, time, weather conditions, speed, etc.) of the vehicle 10, and aspects of the occupant (alertness, tired, distracted) in light of data received from the database 58 including past occurrences of the occupant traveling within the vehicle 10 and the preferences and actions of the occupant 66 when the location of the vehicle 10, operating conditions of the vehicle 10, and aspects of the occupant 66, were identical or substantially similar to the real-time data of the location of the vehicle 10, the operating conditions of the vehicle 10, and aspects of the occupant 66.

Occupants within a vehicle often engage in repeated patterns. Observation of such patterns allows the machine learning model 68 to establish a pattern of behavior, and to predict future behavior based on such patterns. This allows the machine learning model 68 to predict the occupant's 66 intentions.

To create the machine learning model 68, first a generic machine learning model is trained with data collected from a plurality of different vehicles located in a region and climate similar to the vehicle 10. A diverse dataset is collected from vehicles equipped with sensors such as GPS, accelerometers, cameras, radar, and LIDAR. The data encompasses various driving scenarios, including urban, highway, and off-road driving. Before feeding the data into machine learning models, preprocessing steps are undertaken to remove noise, handle missing values, and standardize features. An essential step in driving behavior classification is the extraction of relevant features from the raw data. As mentioned above, various techniques are employed to extract meaningful features from sensor readings, including time-series analysis, frequency-domain analysis, and spatial-temporal patterns. Different types of machine learning algorithms may be used for probabilistic identification of patterns, including but not limited to Long Short-Term Memory (LSTM), Gated Recurrent Unit (GRU), Decision Trees, Random Forests, Support Vector Machines (SVM), Neural Networks (NN), K-Nearest Neighbors (KNN), Gradient Boosting and Recurrent Neural Networks (RNN). The generic machine learning model is trained on a labeled dataset and evaluated using various performance metrics such as accuracy, precision, recall, F1-score, and confusion matrix. The hyperparameters of the models are tuned to achieve optimal results. The generic machine learning model is trained on training data and will learn to map input features to the corresponding pattern (actions) probabilities.

The generic machine learning model is uploaded to the system controller 34A within the vehicle 10. The generic machine learning model provides a basis for creation of driver specific profiles and the machine learning model 68 for the specific occupant 66 of the vehicle 10. The upload of the generic machine learning model may be via a subscription-based service from a third-party provider or the vehicle 10 manufacturer. The machine learning model 68 is ultimately created by updating the generic machine learning model. Once the generic machine learning model is uploaded, data is collected as the vehicle 10 is used day to day. As an occupant 66 travels within the vehicle 10, the generic machine learning model is updated to personalize the generic machine learning model to the specific occupant 66 of the vehicle 10, thus creating the machine learning model 68, which is tailored for the specific occupant 66 of the subject vehicle 10 and is also continuously updated. The system controller 34 may have multiple machine learning models stored therein, each one tailored for a specific occupant, and any time a new occupant of the vehicle 10 is identified by the system controller 34A, via the occupant monitoring system 54, the system controller 34A will begin customizing a copy of the generic machine learning model, creating a unique machine learning model for that occupant 66.

Referring to the example provided above, the occupant 66 may not provide an explicit command, but the system controller 34A may predict that the occupant 66 may want to stop at a hotel soon based on time of day, how long the occupant 66 has been driving, and detection that the occupant 66 is tired. Further, the system controller 34A may predict that the occupant may want breakfast and wants access to a gym based on previous data that indicates sometimes the occupant 66 eats breakfast at the hotel, and the occupant 66 always chooses hotels that have a gym. Finally, the system controller 34A may predict that the occupant wants a hotel close to the highway based on navigation data showing that the occupant 66 will be driving again all day the next day to get to a final destination, and thus will desire easy access back to the highway. Thus, the system controller 34A may determine the intentions of an occupant 66 by directly translating verbal or manually input data, or may infer the intentions of an occupant 66 with probabilistic predictions using the machine learning model 68 and machine learning algorithms.

After collecting data related to the intentions of the occupant 66, the system controller 34A is adapted to develop a request based on the data related to the intentions of the occupant 66 within the vehicle 10. The system controller 34A uses a large language model (LLM) 70 to analyze the data related to the intentions of the occupant 66 within the vehicle 10 and identifies, with the machine learning model 68 and the LLM 70 key terms and qualifier terms of the request.

A large language model is a type of artificial intelligence algorithm that applies neural network techniques with many parameters to process and understand human languages or text using self-supervised learning techniques. Tasks like text generation, machine translation, summary writing, image generation from texts, machine coding, chat-bots, or Conversational AI are applications of the large language model.

A large language model is purely based on deep learning methodologies, and are highly efficient in capturing the complex entity relationships in the text at hand and can generate the text using the semantic and syntactic of that particular language. Large language models operate on the principles of deep learning, leveraging neural network architectures to process and understand human languages. These models, are trained on vast datasets using self-supervised learning techniques. The core of their functionality lies in the intricate patterns and relationships they learn from diverse language data during training. Large language models consist of multiple layers, including feedforward layers, embedding layers, and attention layers. They employ attention mechanisms, like self-attention, to weigh the importance of different tokens in a sequence, allowing the model to capture dependencies and relationships.

Large Language Model's (LLM) architecture is determined by a number of factors, like the objective of the specific model design, the available computational resources, and the kind of language processing tasks that are to be carried out by the LLM. Transformer-based models, which have revolutionized natural language processing tasks, typically follow a general architecture that includes components such as Input Embeddings, wherein the input text is tokenized into smaller units, such as words or sub-words, and each token is embedded into a continuous vector representation, capturing the semantic and syntactic information of the input. Positional Encoding is added to the input embeddings to provide information about the positions of the tokens because transformers do not naturally encode the order of the tokens. This enables the large language model to process the tokens while taking their sequential order into account. Encoders use neural network techniques to analyze the input text and create a number of hidden states that protect the context and meaning of text data. Multiple encoder layers make up the core of a transformer architecture. Self-attention mechanism and feed-forward neural network are the two fundamental sub-components of each encoder layer. The Self-Attention Mechanism enables the model to weigh the importance of different tokens in the input sequence by computing attention scores. It allows the model to consider the dependencies and relationships between different tokens in a context-aware manner. After the self-attention step, a Feed-Forward Neural Network is applied to each token independently. This network includes fully connected layers with non-linear activation functions, allowing the model to capture complex interactions between tokens. In some transformer-based models, a Decoder component is included in addition to the encoder. The decoder layers enable autoregressive generation, where the large language model can generate sequential outputs by attending to the previously generated tokens. Transformers often employ Multi-Head Attention, where self-attention is performed simultaneously with different learned attention weights. This allows the large language model to capture different types of relationships and attend to various parts of the input sequence simultaneously. Layer normalization is applied after each sub-component or layer in the transformer architecture. It helps stabilize the learning process and improves the model's ability to generalize across different inputs. Output Layers of the transformer model can vary depending on the specific task. For example, in language modeling, a linear projection followed by SoftMax activation is commonly used to generate the probability distribution over the next token.

Large language models can generate accurate code based on user instructions for specific tasks, and assist in identifying code errors, suggesting fixes, and even automating project documentation. Users can ask a large language model both casual and complex questions, and receive detailed, context-aware responses. A large language model can translate text between different languages and correct grammatical errors. Large language models excel in one-shot and zero-shot learning scenarios.

Use of the large language model 70 allows the system controller 34A to engage in natural conversations with an occupant 66. The large language model 70 enables the system controller 34A to understand and interpret verbal and textual input (request) and provide textual or verbal responses.

Thus, the system controller 34A, using the LLM 70 and the machine learning model 68 takes the request: “Find a good hotel with optional breakfast and a gym within about thirty to forty-five minutes and not too far from the highway”, and parses the request into key terms and qualifier terms. From the request of the example above, the key terms include “Hotel”, “Breakfast”, “Gym” and “Highway”. Qualifier terms include “Good”, “Optional”, “Thirty to forty-five minutes” and “Not too far”.

The system controller 34A, then uses the LLM 70, the machine learning model 68, real time data collected by the plurality of onboard sensors 40a-40n and data received from remote sources 48 including crowd sourced databases, the internet and other data sources, to quantify the key terms and qualifier terms.

For example, for the qualifier term “Good”, the system controller 34A, using the LLM 70 to interpret and translate, the machine learning model 68 to understand personal preferences of the occupant 66, and data from remote sources to understand conventional wisdom of what constitutes a “good” hotel, quantifies what “good” means to the occupant 66, and establishes a standard. Thus, the system controller 34A determines that a “good” hotel must have a rating of four-stars or better with at least 100 published reviews.

The “Optional” breakfast is interpreted and quantified to mean that breakfast may or may not be included within the price of the hotel room, either will be acceptable to the occupant. “About thirty to forty-five minutes” is interpreted and quantified to mean the hotel should be within forty to sixty miles from the current location of the vehicle 10, calculated by the system controller 34A using current vehicle speed, traffic conditions, etc. Finally, “not too far” from the highway is interpreted and quantified to mean the hotel should be no further than five miles from the highway. Again these determinations are based on probabilistic predictions by the machine learning model 68 and the LLM 70 with data related to the occupant's 66 past actions and preferences, and data related to conventional norms based on crowd-sourced data.

The key terms and qualifier terms of the request have now been quantified, converting the request from:
“Find a good hotel with optional breakfast and a gym within about thirty to forty-five minutes and not too far from the highway”;
to;
“Find a hotel with at least a four-star rating based on at least 100 published reviews, that has a gym, is within sixty miles of the vehicle's current location and is within five miles of the highway.”

After the key terms and qualifier terms from the request have been quantified, the system controller 34A is adapted to collect data from the plurality of onboard sensors 40a-40n related to the request and to receive, via the wireless communication module 36, data from remote sources 48 related to the request.

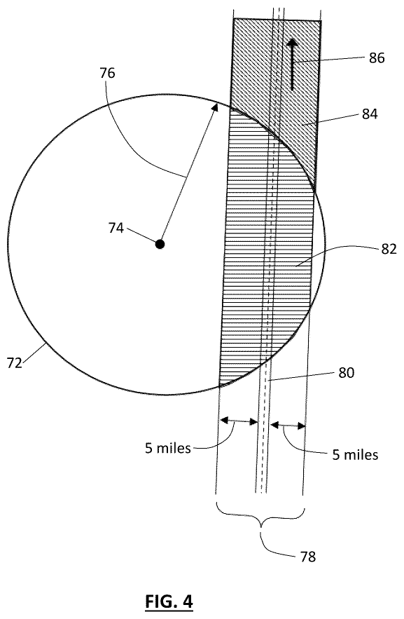

In an exemplary embodiment, the system controller 34A is adapted to identify a geographic area within which relevant data related to the request will be collected, collect relevant data related to the request within the geographic area, and filter the collected data based on the key terms and qualifier terms. Referring to FIG. 4, using the example above, the system controller 34A will identify a circle 72 with a center 74 at the current location of the vehicle 10 and the radius 76 being sixty miles, and a band 78 that extends five miles on either side of the highway 80. The geographic area 82 within which relevant data related to the request will be collected is defined as the area where the circle 72 and the band 78 overlap. Thus, the system controller 34A will search within that geographic area 82 to find a suitable hotel for the occupant 66.

In another exemplary embodiment, when collecting data from the plurality of onboard sensors 40a-40n related to the request and receiving, via the wireless communication module 36, data from remote sources 48 related to the request, the system controller 34A is further adapted to identify, using the machine learning model 68, unspecified key terms and unspecified qualifier terms, related to the request and not included within the request. The machine learning model 68 will use real time data of the location of the vehicle, date, and preferences of the occupant 66 to identify unspecified key terms and unspecified qualifier terms.

For example, using the request from above, the occupant 66 did not say anything about a pool at the hotel, and therefore, the original request did not include key terms or qualifier terms related to presence of a pool or specifics about the pool. However, the machine learning model 68 identifies within the database 58 a pattern wherein a majority of the time, the occupant 66 stays at hotels that have a pool, and moreover, there were multiple instances where the occupant used the system 50 and explicitly requested a pool at a hotel. Thus, the system controller 34A, using the machine learning model 68, will include the unspecified term “Pool” in the request. Further, the machine learning model 68 will identify, using data from the plurality of sensors related to weather/temp, and data from remote sources that the forecast is calling for cold weather, and, using data from the database 58 identifies a pattern wherein the occupant 66 stays at hotels with indoor pools when it is cold outside. Thus, the system controller 34A, using the machine learning model 68, will include the unspecified qualifier term “Indoor” with the unspecified key term “Pool” and include “Indoor Pool” in the request.

In another example, the system controller 34A, using data from remote sources, identifies a new hotel that has an indoor water park attached thereto. During previous occasions of the occupant 66 traveling through the area this hotel was not yet built, and was not an option. Thus, the system controller 34A identifies a potential key term that the occupant 66 may wish to include in the request, whereupon, the system controller 34A may automatically include the “Indoor Water Park” as an unspecified key term, or may prompt the occupant 66 as to the occupant's preferences with regard to the indoor water park. If this is the first time, the database 58 will not include any data related to the indoor water park, so the system controller 34A may, in addition to prompting occupant 66 for input on preferences for the indoor water park, prompts the occupant 66 for preferences with respect to ranking the indoor water park against other key terms.

In this way, the system controller 34A can fine tune the request to preferences of the occupant 66, even when the data collected and behavior displayed by the occupant 66 did not indicate to the system controller 34A that the occupant's intentions include unspecified key terms and unspecified qualifier terms. This allows the system 50 to provide more accurate interpretation of an occupant's intentions and take into account new data not previously available, and thus provide more acceptable responses to the occupant 66.

In another exemplary embodiment, when collecting data from the plurality of onboard sensors 40a-40n related to the request and receiving, via the wireless communication module 36, data from remote sources 48 related to the request, the system controller 34A is further adapted to identify an extended geographic area 84 within which relevant data related to the request, including unspecified key terms and unspecified qualifier terms, will be collected. Referring again to FIG. 4, the system controller 34A, using navigation data and the machine learning model 68, predicts that after spending the night in the hotel, the occupant 66 will proceed, in the vehicle 10, along the highway, as indicated by arrow 86. The system controller 34A will define an extended geographical area 84 that is positioned further away than the qualifier term “forty to 60 miles away”, but may include better hotel options that meet the requirements of other key terms, qualifier terms, unspecified key terms or unspecified qualifier terms, and, even though further away, is along the projected future route of the occupant 66, and thus, may be more preferred by the occupant 66.

In an exemplary embodiment, the system controller 34A, using the LLM 70 and the machine learning model 68 is adapted to rank key terms and qualifier terms, by predicting which of the key terms and qualifier terms are more important to the occupant 66. Thus, referring again to the example above, the request included the terms “gym” and “within forty to sixty miles”, however, based on past data, the occupant 66 has shown a pattern of always selecting hotels that have a gym. Thus, the system controller 34A, ranks the presence of a gym higher than the distance term, and, using the machine learning model 68, predicts that the occupant 66 would be willing to drive a few extra miles to reach a hotel that provides a gym. Therefore, if searching within the geographic area 80 does not provide a hotel that provides a gym, the system controller 34A will search within the extended geographic area 84 to see if a hotel further away provides a gym. It should be understood that ranking of the key terms and qualifier terms may be based on occupant 66 preferences identified by the machine learning model 68, or environmental or vehicle operational parameters, such as, by way of example, ranking a preference for a paved highway higher than a preference for a scenic drive along rural road when weather conditions make driving conditions less than optimal.

After the system controller 34A collects relevant data related to the geographic area 82 and the extended geographic area 84, the system controller collectively filters all of the data based on the key terms, qualifier terms, unspecified key terms and unspecified qualifier terms, wherein, the system controller 34A, using the LLM 70 via the wireless communication module 36, formulates a response and actuates systems within the vehicle 10 to automatically, at least one of provide, via the HMI 56, infotainment content for the occupant 66 within the vehicle 10, and control, via an automated driving assistance system (ADAS), operation of the vehicle 10.

In an exemplary embodiment, when formulating, with the LLM 70, the response, and actuating systems within the vehicle 10 to automatically provide, via the HMI 56, infotainment content for the occupant 66 within the vehicle, the system controller 34A is further adapted to formulate, with the LLM 70, a natural language response for the occupant 66, and at least one of display a textual language response on the touch screen display 60 of the HMI 56, and broadcast, via the speaker 64 associated with the HMI 56, a verbal response for the occupant 66. For example, the response formulated for the request “Find a good hotel with optional breakfast and a gym within about thirty to forty-five minutes and not too far from the highway”, the system controller 34A may identify a plurality of matching hotels that fall within the geographic area 82 and satisfy the occupant's 66 preferences with respect to identified key terms, qualifier terms, unspecified key terms and unspecified qualifier terms. The response may be a list of the identified matching hotels displayed on the touch screen display 60 of the HMI for the occupant 66, wherein the occupant 66 can view the listing and make a selection. Alternatively, or in combination, the system controller 34A, using the LLM 70 formulates a natural language response, wherein the list of matching hotels is “read” to the occupant 66 over the speaker 64 of the HMI 56. At any time during the “reading” of the list of hotels, the occupant 66 may interrupt with a verbal selection of one of the matching hotels.

In another exemplary embodiment, when formulating, with the LLM 70, a response, and actuating systems within the vehicle 10 to automatically control, via the ADAS, operation of the vehicle 10, the system controller 34A is further adapted to identify, with the LLM 70 and the machine learning model 68, a desired vehicle operation based on the request, and automatically, via the ADAS, perform the desired vehicle operation. For example, the response formulated for the request “Find a good hotel with optional breakfast and a gym within about thirty to forty-five minutes and not too far from the highway”, the system controller 34A may identify a plurality of matching hotels that fall within the geographic area 82 and satisfy the occupant's 66 preferences with respect to identified key terms, qualifier terms, unspecified key terms and unspecified qualifier terms. The system controller 34A, using the machine learning model 68 and machine learning techniques can rank the identified matching hotels, and automatically select the highest ranked one of the plurality of matching hotels, wherein, the system controller 34A automatically actuates autonomous features of the ADAS 52 to provide autonomous navigation of the vehicle 10 to the highest ranked one of the plurality of matching hotels. Simultaneously, the system controller 34A may display the list including the identified plurality of matching hotels on the touch screen display 60 of the HMI 56, allowing the occupant 66 to see the list, and see the identified highest ranked one of the plurality of matching hotels. If the occupant 66 desires, the occupant 66 may manually or verbally provide instruction to over-ride the automatic selection by the system controller 34A, and verbally or manually select a different one of the plurality of matching hotels, wherein the system controller will actuate the ADAS 52 to autonomously navigate the vehicle 10 to the hotel selected by the occupant 66.

By using the LLM 70 along with the machine learning model 68, the system controller 34A can provide a wide variety of infotainment content to an occupant 66 or occupants within the vehicle 10. As detailed in the example above, the system 50 can identify specific commands given by an occupant 66, interpret the commands using machine learning and an LLM 70, and provide content including options that the occupant 66 can select from. In other scenarios, the system controller 34A may, using the plurality of onboard sensors 40a-40n and the occupant monitoring system 54, identify data that the LLM 70 interprets as restless children within the vehicle 10, wherein, the system controller, using the LLM 70 interprets the data as an intention of the occupant 66 and a request to provide entertaining infotainment for the children, and a response developed by the system controller 34A includes, accessing, via the wireless communication module 36, a subscription that the occupant 66 (parent driver) has to a book or movie service (remote entity 48), selection, with the machine learning model 68 and the LLM 70 of a story or a movie based on the age and interests (based on prior data, machine learning model 68, database 58) of the children, wherein, the system controller 34A, utilizing the LLM 70, will automatically display the movie or “read” the story to the children using the HMI 56.

Using the LLM 70 and data collected from crowd-sourced remote entities 48, the system 50 can provide qualitative responses to an occupant's 66 request. For example, an occupant 66 may verbally provide a request “Hey Vehicle, rank my driving on this trip compared to my parents and also to general behaviors.” The system controller 34A, along with the LLM 70 and the machine learning model 68 will identify key terms such as “rank”, “my driving”, “compared”, “parents” and “general behaviors”, as well as qualifier terms such as “this trip”. Wherein the system controller 34A using the LLM 70 and data related to best behaviors from crowd-sourced remote entities 48, quantifies the occupant's rank as good, average or bad, or alternatively ranked from one to ten, wherein one is the best and ten is bad, using driving characteristics of the occupant 66, such as lane changing behavior, accurately following lanes and/or routes, following traffic rules, and obeying traffic signals, data for which is collected by the plurality of onboard sensors 40a-40n within the vehicle 10. The system controller 34A will further compare the quantified data for the occupant 66 against similar quantified data collected by the system controller 34A and stored within the database 58 during instances where the parents of the occupant 66 were traveling in/driving the vehicle 10, wherein the system controller 34A will quantify the occupant's rank as good, average or bad, or ranked from one to ten as compared to behaviors of the parents of the occupant 66. The qualifier term “this trip” means that the occupant 66 wants to know how their driving behavior ranks only for the current driving event (since last start-up until the vehicle 10 is parked again), thus, the system controller 34A will only use data for the occupant 66 that has been collected during the current driving event, versus, using data for the occupant collected during the current driving event and pulled from the database 58 from past driving events by the occupant 66.

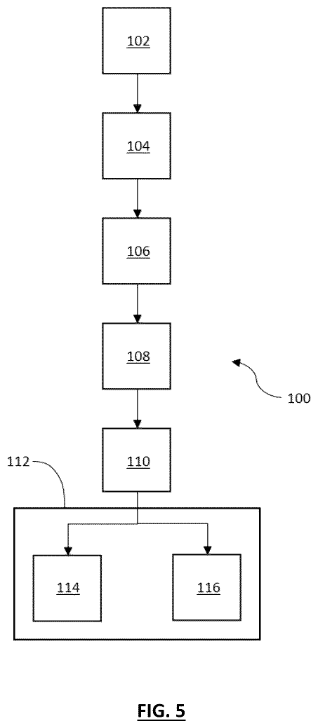

Referring to FIG. 5, a method 100 of providing intention-based infotainment within a vehicle 10, comprising, with a system controller 34A in communication with a plurality of onboard sensors 40a-40n within the vehicle 10 includes, starting at block 102, collecting data related to intentions of an occupant 66 within the vehicle 10, moving to block 104, developing a request based on the data related to the intentions of the occupant 66 within the vehicle 10, moving to block 106, collecting data from the plurality of onboard sensors 40a-40n related to the request, moving to block 108, receiving, via a wireless communication module 36, data from remote sources 48 related to the request, moving to block 110, formulating, with a large language model (LLM) 70 in communication with the system controller 34A via the wireless communication module 36, a response, and, moving to block 112, actuating systems within the vehicle 10 to automatically, at least one of, moving to block 114, provide, via a human machine interface (HMI) 56, infotainment content for the occupant 66 within the vehicle 10, and, moving to block 116, controlling, via an automated driving assistance system (ADAS) 52, operation of the vehicle 10.

In an exemplary embodiment, the collecting data related to intentions of an occupant 66 within the vehicle 10 at block 102 further includes at least one of collecting, with an occupant monitoring system 54 data related to what the occupant 66 is looking at, gestures made by the occupant 66, and facial expressions of the occupant 66, and collecting, with the HMI 56, verbal expressions made by the occupant 66 and manual data input from the occupant 66.

In another exemplary embodiment, the collecting data related to intentions of an occupant 66 within the vehicle 10 at block 102 further includes accessing, with a machine learning model 68, stored data within a database 58 related to past occurrences of the occupant 66 using the vehicle 10.

In another exemplary embodiment, the developing a request based on the data related to the intentions of the occupant 66 within the vehicle 10 at block 104 further includes detecting, with the system controller, one of triggering language from the occupant 66, via the HMI 56, or a triggering event, via the plurality of onboard sensors 40a-40n.

In another exemplary embodiment, the developing a request based on the data related to the intentions of the occupant 66 within the vehicle 10 at block 104 further includes predicting, with the machine learning model 68, intentions of the occupant 66 based on the data stored within the database 58, analyzing, with the LLM 70, the data related to the intentions of the occupant 66 within the vehicle 10, identifying, with the machine learning model 68 and the LLM 70, key terms and qualifier terms, and quantifying, with the system controller 34A, using the LLM 70, the machine learning model 68, real time data collected by the plurality of onboard sensors 40a-40n and data received from remote sources 48, the key terms and qualifier terms.

In another exemplary embodiment, the collecting data from the plurality of onboard sensors 40a-40n related to the request at block 106, and the receiving, via the wireless communication module 36, data from remote sources 48 related to the request at block 108, further includes identifying, with the system controller 34A, a geographic area 82 within which relevant data related to the request will be collected, collecting relevant data related to the request within the geographic area 82, and filtering the collected data based on the key terms and qualifier terms.

In another exemplary embodiment, the collecting data from the plurality of onboard sensors 40a-40n related to the request at block 106 and the receiving, via the wireless communication module 36, data from remote sources related to the request at block 108, further includes identifying, with the system controller 34A, using the machine learning model 68, unspecified key terms and unspecified qualifier terms, related to the request and not included within the request.

In another exemplary embodiment, the collecting data from the plurality of onboard sensors 40a-40n related to the request at block 106 and the receiving, via the wireless communication module 36, data from remote sources 48 related to the request at block 108, further includes identifying, with the system controller 34A, an extended geographic area 84 within which relevant data related to the request, including unspecified key terms and unspecified qualifier terms, will be collected, collecting relevant data related to the request within the extended geographic area 84, and filtering the collected data based on the key terms, qualifier terms, unspecified key terms and unspecified qualifier terms.

In another exemplary embodiment, the formulating, with a large language model (LLM) 70 in communication with the system controller 34A via the wireless communication module 36, a response at block 110, and actuating systems within the vehicle 10 to automatically provide, via the HMI 56, infotainment content for the occupant 66 within the vehicle 10 at block 114, further includes formulating, with the LLM 70, a natural language response for the occupant 66; and at least one of displaying a textual language response on a touch screed display 60 of the HMI 56, and broadcasting, via a speaker 64 associated with the HMI 56, a verbal response for the occupant 66.

In yet another exemplary embodiment, the formulating, with a large language model (LLM) 70 in communication with the system controller 34A via the wireless communication module 36, a response at block 110, and actuating systems within the vehicle 10 to automatically control, via an automated driving assistance system (ADAS) 52, operation of the vehicle 10 at block 116, further includes identifying, with the LLM 70 and the machine learning model 68, a desired vehicle operation based on the request, and automatically, via the ADAS 52, performing the desired vehicle operation.

A system 50 and method 100 of the present disclosure offers the advantage of providing infotainment content that is either explicitly requested or inferred based on data collected related to intentions of an occupant 66, by using a large language model 70 to interpret the occupant's 66 intentions and using a machine learning model 68 to predict the occupant's 66 intentions based on past behavior, and using the large language model 70 and machine learning model 68 to formulate a request based on the occupant's 66 intentions and formulate a response to provide infotainment content to the occupant 66 and/or provide automatic vehicle 10 control in response to the intentions of the occupant 66.

The description of the present disclosure is merely exemplary in nature and variations that do not depart from the gist of the present disclosure are intended to be within the scope of the present disclosure. Such variations are not to be regarded as a departure from the spirit and scope of the present disclosure.

1. A method of providing intention-based infotainment within a vehicle, comprising, with a system controller in communication with a plurality of onboard sensors within the vehicle:
collecting data related to intentions of an occupant within the vehicle;
developing a request based on the data related to the intentions of the occupant within the vehicle;
collecting data from the plurality of onboard sensors related to the request;
receiving, via a wireless communication module, data from remote sources related to the request;
formulating, with a large language model (LLM) in communication with the system controller via the wireless communication module, a response; and
actuating systems within the vehicle to automatically:
provide, via a human machine interface (HMI), infotainment content for the occupant within the vehicle; and
control, via an automated driving assistance system (ADAS), operation of the vehicle.

2. The method of claim 1, wherein the collecting data related to intentions of an occupant within the vehicle further includes at least one of:
collecting, with an occupant monitoring system data related to what the occupant is looking at, gestures made by the occupant, and facial expressions of the occupant; and
collecting, with the HMI, verbal expressions made by the occupant and manual data input from the occupant.

3. The method of claim 2, wherein the collecting data related to intentions of an occupant within the vehicle further includes accessing, with a machine learning model, stored data within a database related to past occurrences of the occupant using the vehicle.

4. The method of claim 3, wherein the developing a request based on the data related to the intentions of the occupant within the vehicle further includes:
detecting, with the system controller, one of:
triggering language from the occupant, via the HMI; or
a triggering event, via the plurality of onboard sensors.

5. The method of claim 4, wherein the developing a request based on the data related to the intentions of the occupant within the vehicle further includes:
predicting, with the machine learning model, intentions of the occupant based on the data stored within the database;
analyzing, with the LLM, the data related to the intentions of the occupant within the vehicle;
identifying, with the machine learning model and the LLM, key terms and qualifier terms; and
quantifying, with the system controller, using the LLM, the machine learning model, real time data collected by the plurality of onboard sensors and data received from remote sources, the key terms and qualifier terms.

6. The method of claim 5, wherein the collecting data from the plurality of onboard sensors related to the request and the receiving, via the wireless communication module, data from remote sources related to the request further includes:
identifying, with the system controller, a geographic area within which relevant data related to the request will be collected;
collecting relevant data related to the request within the geographic area; and
filtering the collected data based on the key terms and qualifier terms.

7. The method of claim 6, wherein the collecting data from the plurality of onboard sensors related to the request and the receiving, via the wireless communication module, data from remote sources related to the request further includes:
identifying, with the system controller, using the machine learning model, unspecified key terms and unspecified qualifier terms, related to the request and not included within the request.

8. The method of claim 7, wherein the collecting data from the plurality of onboard sensors related to the request and the receiving, via the wireless communication module, data from remote sources related to the request further includes:
identifying, with the system controller, an extended geographic area within which relevant data related to the request, including unspecified key terms and unspecified qualifier terms, will be collected;
collecting relevant data related to the request within the extended geographic area; and
filtering the collected data based on the key terms, qualifier terms, unspecified key terms and unspecified qualifier terms.

9. The method of claim 8, wherein the formulating, with a large language model (LLM) in communication with the system controller via the wireless communication module, a response, and actuating systems within the vehicle to automatically provide, via the HMI, infotainment content for the occupant within the vehicle further includes:
formulating, with the LLM, a natural language response for the occupant; and at least one of:
displaying a textual language response on a touch screen display of the HMI; and
broadcasting, via a speaker associated with the HMI, a verbal response for the occupant.

10. The method of claim 9, wherein the formulating, with a large language model (LLM) in communication with the system controller via the wireless communication module, a response, and actuating systems within the vehicle to automatically control, via an automated driving assistance system (ADAS), operation of the vehicle further includes:
identifying, with the LLM and the machine learning model, a desired vehicle operation based on the request; and
automatically, via the ADAS, performing the desired vehicle operation.

11. A system for providing intention-based infotainment within a vehicle, comprising:
a system controller in communication with a plurality of onboard sensors within the vehicle and adapted to:
collect data related to intentions of an occupant within the vehicle;
develop a request based on the data related to the intentions of the occupant within the vehicle;
collect data from the plurality of onboard sensors related to the request;
receive, via a wireless communication module, data from remote sources related to the request;
formulate, with a large language model (LLM) in communication with the system controller, via the wireless communication module, a response; and
actuate systems within the vehicle to automatically:
provide, via a human machine interface (HMI), infotainment content for the occupant within the vehicle; and
control, via an automated driving assistance system (ADAS), operation of the vehicle.

12. The system of claim 11, wherein when collecting data related to intentions of an occupant within the vehicle, the system controller is further adapted to at least one of:
collect, with an occupant monitoring system data related to what the occupant is looking at, gestures made by the occupant, and facial expressions of the occupant; and
collect, with the HMI, verbal expressions made by the occupant and manual data input from the occupant.

13. The system of claim 12, wherein when collecting data related to intentions of an occupant within the vehicle, the system controller is further adapted to access, with a machine learning model, stored data within a database related to past occurrences of the occupant using the vehicle.

14. The system of claim 13, wherein when developing a request based on the data related to the intentions of the occupant within the vehicle, the system controller is further adapted to detect one of triggering language from the occupant, via the HMI, or a triggering event, via the plurality of onboard sensors.

15. The system of claim 14, wherein when developing a request based on the data related to the intentions of the occupant within the vehicle, the system controller is further adapted to:
predict, with the machine learning model, intentions of the occupant based on the data stored within the database;
analyze, with the LLM, the data related to the intentions of the occupant within the vehicle;
identify, with the machine learning model and the LLM, key terms and qualifier terms; and
quantify, using the LLM, the machine learning model, real time data collected by the plurality of onboard sensors and data received from remote sources, the key terms and qualifier terms.

16. The system of claim 15, wherein when collecting data from the plurality of onboard sensors related to the request and receiving, via the wireless communication module, data from remote sources related to the request, the system controller is further adapted to:
identify a geographic area within which relevant data related to the request will be collected;
collect relevant data related to the request within the geographic area; and
filter the collected data based on the key terms and qualifier terms.

17. The system of claim 16, wherein when collecting data from the plurality of onboard sensors related to the request and receiving, via the wireless communication module, data from remote sources related to the request, the system controller is further adapted to identify, using the machine learning model, unspecified key terms and unspecified qualifier terms, related to the request and not included within the request.

18. The system of claim 17, wherein when collecting data from the plurality of onboard sensors related to the request and receiving, via the wireless communication module, data from remote sources related to the request, the system controller is further adapted to:
identify an extended geographic area within which relevant data related to the request, including unspecified key terms and unspecified qualifier terms, will be collected;
collect relevant data related to the request within the extended geographic area; and
filter the collected data based on the key terms, qualifier terms, unspecified key terms and unspecified qualifier terms.

19. The system of claim 18, wherein:
when formulating, with a large language model (LLM) in communication with the system controller via the wireless communication module, a response, and actuating systems within the vehicle to automatically provide, via the HMI, infotainment content for the occupant within the vehicle, the system controller is further adapted to formulate, with the LLM, a natural language response for the occupant, and at least one of display a textual language response on a touch screen display of the HMI, and broadcast, via a speaker associated with the HMI, a verbal response for the occupant; and
when formulating, with a large language model (LLM) in communication with the system controller via the wireless communication module, a response, and actuating systems within the vehicle to automatically control, via an automated driving assistance system (ADAS), operation of the vehicle, the system controller is further adapted to identify, with the LLM and the machine learning model, a desired vehicle operation based on the request, and automatically, via the ADAS, perform the desired vehicle operation.

20. A vehicle having a system for providing intention-based infotainment, the system comprising:
a system controller in communication with a plurality of onboard sensors within the vehicle and adapted to:
collect data related to intentions of an occupant within the vehicle, wherein the system controller is adapted to at least one of:
collect, with an occupant monitoring system data related to what the occupant is looking at, gestures made by the occupant, and facial expressions of the occupant;
collect, with the HMI, verbal expressions made by the occupant and manual data input from the occupant; and
access, with a machine learning model, stored data within a database related to past occurrences of the occupant using the vehicle;
develop a request based on the data related to the intentions of the occupant within the vehicle, wherein the system controller is adapted to:
detect one of triggering language from the occupant, via the HMI, or a triggering event, via the plurality of onboard sensors;
predict, with the machine learning model, intentions of the occupant based on the data stored within the database;
analyze, with the LLM, the data related to the intentions of the occupant within the vehicle;
identify, with the machine learning model and the LLM, key terms and qualifier terms; and
quantify, using the LLM, the machine learning model, real time data collected by the plurality of onboard sensors and data received from remote sources, the key terms and qualifier terms;
collect data from the plurality of onboard sensors related to the request and receive, via a wireless communication module, data from remote sources related to the request, wherein the system controller is adapted to:
identify a geographic area within which relevant data related to the request will be collected;
collect relevant data related to the request within the geographic area;
identify, using the machine learning model, unspecified key terms and unspecified qualifier terms, related to the request and not included within the request;
identify an extended geographic area within which relevant data related to the request, including unspecified key terms and unspecified qualifier terms, will be collected;
collect relevant data related to the request within the extended geographic area; and
filter the collected data based on the key terms, qualifier terms, unspecified key terms and unspecified qualifier terms;
formulate, with the LLM in communication with the system controller, via the wireless communication module, a response; and
actuate systems within the vehicle to automatically:
provide, via the HMI, infotainment content for the occupant within the vehicle; and
control, via an automated driving assistance system (ADAS), operation of the vehicle.
